(19) United States
(12) Patent Application Publication
(10) Pub. No.: US 2014/0082727 A1
(43) Pub. Date: Mar. 20, 2014

(54) ELECTRONIC DEVCIE AND METHOD FOR MONITORING APPLICATION

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventors: SI-QUAN CHEN, New Taipei (TW); HUO WU, Shenzhen (CN); JUN-NAN FAN, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/858,075

(22) Filed: Apr. 7, 2013

(30) Foreign Application Priority Data
Sep. 18, 2012 (CN) 201210345518.X

(51) Int. Cl. G06F 21/56

(52) U.S. Cl. CPC G06F 21/56
USPC 726/23

(57) ABSTRACT

An electronic device includes an operating system to determine hardware modules being used when an application of the electronic device is run. The electronic device stores a table recording hardware modules used by the running of each application obtained from a creditable service provider. The electronic device obtains the hardware modules being used by the operating system when an application is running, determines whether all the hardware modules being used are the hardware modules corresponding to the running application in the table if the running application is recorded in the table, and determines that the running application is a malicious application if not all of the hardware modules being used are the hardware modules corresponding to the running application in the table. The electronic device executes a safeguard operation to protect the electronic device when the running application is a malicious application. A related method is also provided.

### BACKGROUND

1. Technical Field

The present disclosure relates to electronic devices, and particularly to an electronic device capable of monitoring applications and a method thereof.

2. Description of Related Art

Various applications (e.g., game applications) can be downloaded to electronic devices (e.g., smart phones) through a network. The use of some downloaded applications may be a spyware and poses a threat to data integrity, and may, for example, risk exposing important personal information. However, it is difficult for users to judge whether an application is a spyware or not. Thus, it is desirable to provide an electronic device and a method capable of automatically judging malicious applications to solve the above problems.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of an electronic device for monitoring applications, in accordance with an exemplary embodiment.

FIG. 2 is a flowchart of a method for monitoring applications, in accordance with an exemplary embodiment.

### DETAILED DESCRIPTION

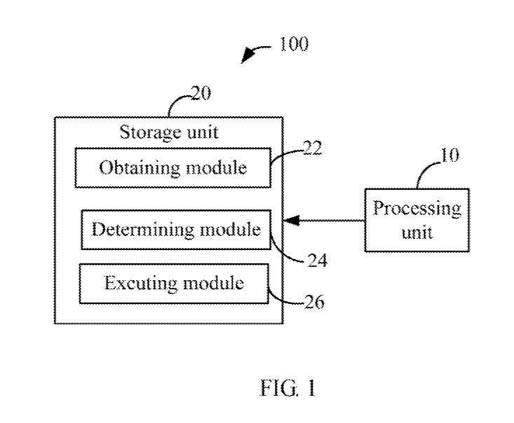

FIG. 1 shows an embodiment of an electronic device 100 capable of monitoring applications. The electronic device 100 may be a smart phone, a computer, or the like. Generally, when the electronic device 100 runs an application obtained from a creditable service provider, the electronic device 100 may be in a safe state. When the electronic device 100 runs an application not obtained from a creditable service provider, the electronic device 100 may not be in a safe state for the running of the application may illegally use some hardware modules (e.g. network module) of the electronic device 100 to cause information leakage. In the embodiment, the electronic device 100 can automatically judge whether a running application is malicious, and execute a safeguard operation to protect the electronic device 100 when a malicious application is running.

The operating system of the electronic device 100 can determine all hardware modules being used when an application is running. The hardware modules may include a network module, a Bluetooth module, and a camera module. The electronic device 100 stores a table recording hardware modules being used by the running of each application obtained from a creditable service provider. In this embodiment, when an application is running, and the hardware modules being used by the operating system are the hardware modules corresponding to the application in the table, the application is determined to be a safe application, otherwise, the application is determined to be a malicious application. The hardware modules being used which are not the hardware modules corresponding to the application in the table are hereinafter referred as hardware modules being illegally used.

In the embodiment, the electronic device 100 includes a processing unit 10 and a storage unit 20. The storage unit 20 stores the table and a number of modules. The modules include an obtaining module 22, a determining module 24, and an executing module 26, which are executed by the processing unit 10 to perform functions of the electronic device 100.

The obtaining module 22 is operable to obtain the hardware modules being used by the operating system of the electronic device 100 when an application is running.

The determining module 24 is operable to determine whether the running application is recorded in the table, determine whether all the hardware modules being used are the hardware modules corresponding to the running application in the table if the running application is recorded in the table, and determine that the running application is malicious if not all of the hardware modules being used are the hardware modules corresponding to the running application in the table.

The executing module 26 is operable to execute a safeguard operation to protect the electronic device 100 when the running application is a malicious application. The executing module 16 can output a prompt to prompt that the running application is a malicious application, or directly disable the running application. Furthermore, the executing module 26 firstly computes a malicious coefficient of the hardware modules being illegally used, and then executes a safeguard operation according to the computed malicious coefficient. If the computed malicious coefficient is less than a preset value, the executing module 26 outputs a prompt, and if the computed malicious coefficient is equal to or greater than the preset value, the executing module 26 directly disables the running application. In a first embodiment, when the number of the hardware module being illegally used increases 1, the malicious coefficient increases 10%. In a second embodiment, different hardware modules correspond to different malicious coefficients. For example, the malicious coefficient of the camera module is 10%, and the malicious coefficient of the network module is 30%.

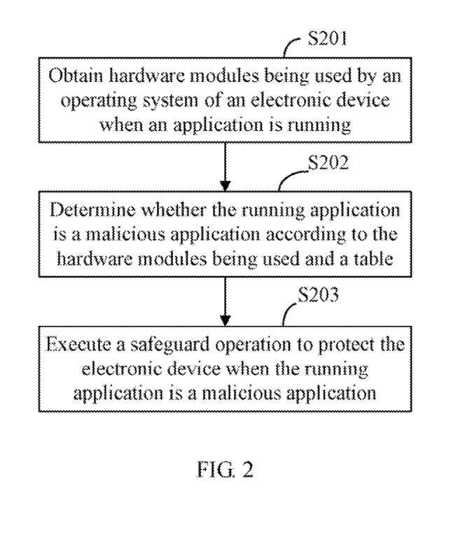

FIG. 2 is a flowchart of a method for monitoring applications, in accordance with an exemplary embodiment.

In step S201, the obtaining module 22 is operable to obtain the hardware modules being used by the operating system of the electronic device 100 when an application is running.

In step S202, the determining module 24 is operable to determine whether the running application is a malicious application according to the obtained hardware modules and the table. In detail, the determining module 24 is operable to determine whether the running application is recorded in the table. If the running application is recorded in the table, the determining module 24 determines whether all the hardware modules being used are the hardware modules corresponding to the running application in the table, and determines that the running application is malicious if not all of the hardware modules being used are the hardware modules corresponding to the running application in the table.

In step S203, the executing module 26 is operable to execute a safeguard operation to protect the electronic device 100 when the running application is a malicious application.

With such configuration, when an application is run, if some additional hardware modules are used, the electronic device 100 determines that the running of the application may illegally use the additional hardware modules to cause information leakage, thus the electronic device 100 executes corresponding safeguard operation to protect the electronic device 100.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device for monitoring applications of the electronic device, comprising:
an operating system to determine hardware modules being used when an application of the electronic device is running;
a storage unit storing a plurality of modules and a table recording hardware modules being used by the running of each application obtained from a creditable service provider; and
a processor to execute the plurality of modules;
wherein the plurality of modules comprises:
an obtaining module operable to obtain the hardware modules being used by the operating system of the electronic device when an application is running;
a determining module operable to determine whether the running application is recorded in the table, determine whether all the hardware modules being used are the hardware modules corresponding to the running application in the table if the running application is recorded in the table, and further determine that the running application is a malicious application if not all of the hardware modules being used are the hardware modules corresponding to the running application in the table; and
an executing module operable to execute a safeguard operation to protect the electronic device when the running application is a malicious application.

2. The electronic device as described in claim 1, wherein the executing module is operable to execute a safeguard operation to protect the electronic device when the running application is a malicious application comprises: the executing module is operable to output a prompt to prompt that the running application is a malicious application when the running application is a malicious application.

3. The electronic device as described in claim 1, wherein the executing module is operable to execute a safeguard operation to protect the electronic device when the running application is a malicious application comprises: the executing module is operable to disable the running application when the running application is a malicious application.

4. The electronic device as described in claim 1, wherein the executing module is further operable to compute a malicious coefficient of using the hardware modules being used which are not the hardware modules corresponding to the running application in the table, and execute the safeguard operation according to the computed malicious coefficient.

5. The electronic device as described in claim 4, wherein the executing module is operable to execute the safeguard operation according to the computed malicious coefficient comprises: the executing module is operable to output a prompt to prompt that the running application is a malicious application when the computed malicious coefficient is less than a preset value.

6. The electronic device as described in claim 5, wherein the executing module is operable to execute the safeguard operation according to the computed malicious coefficient comprises: the executing module is operable to disable the running application when the malicious coefficient is equal to or greater than the preset value.

7. An application monitoring system applied in an electronic device, the electronic device comprising an operating system, a storage unit, and a processor, the operating system being to determine hardware modules being used when an application of the electronic device is run, the storage unit storing a plurality of modules and a table recording hardware modules used by the running of each application obtained from a creditable service provider, the processor being to execute a plurality of modules of the application monitoring system, the plurality of modules comprising:
an obtaining module operable to obtain the hardware modules being used by the operating system of the electronic device when an application is running;
a determining module operable to determine whether the running application is recorded in the table, determine whether all the hardware modules being used are the hardware modules corresponding to the running application in the table if the running application is recorded in the table, and further determine that the running application is a malicious application if not all of the hardware modules being used are the hardware modules corresponding to the running application in the table; and
an executing module operable to execute a safeguard operation to protect the electronic device when the running application is a malicious application.

8. The application monitoring system as described in claim 7, wherein the executing module is operable to execute a safeguard operation to protect the electronic device when the running application is a malicious application comprises: the executing module is operable to output a prompt to prompt that the running application is a malicious application when the running application is a malicious application.

9. The application monitoring system as described in claim 7, wherein the executing module is operable to execute a safeguard operation to protect the electronic device when the running application is a malicious application comprises: the executing module is operable to disable the running application when the running application is a malicious application.

10. The application monitoring system as described in claim 7, wherein the executing module is further operable to compute a malicious coefficient of the hardware modules being used which are not the hardware modules corresponding to the running application in the table, and execute the safeguard operation according to the computed malicious coefficient.

11. The application monitoring system as described in claim 10, wherein the executing module is operable to execute the safeguard operation according to the computed malicious coefficient comprises: the executing module is operable to output a prompt to prompt that the running application is a malicious application when the computed malicious coefficient is less than a preset value.

12. The application monitoring system as described in claim 10, wherein the executing module is operable to execute the safeguard operation according to the computed malicious coefficient comprises: the executing module is operable to disable the running application when the malicious coefficient is equal to or greater than the preset value.

13. A method for monitoring applications of an electronic device, an operating system of the electronic device being to determine hardware modules being used when an application of the electronic device is running, the electronic device storing a table recording hardware modules used by the running of each application obtained from a creditable service provider, the method comprising:
obtaining the hardware modules being used by the operating system of the electronic device when an application is running;
determining whether the running application is recorded in the table;
determining whether all the hardware modules being used are the hardware modules corresponding to the running application in the table if the running application is recorded in the table;
determining that the running application is a malicious application if not all of the hardware modules being used are the hardware modules corresponding to the running application in the table; and
executing a safeguard operation to protect the electronic device when the running application is a malicious application.

14. The method as described in claim 13, wherein the method of executing a safeguard operation to protect the electronic device when the running application is a malicious application comprises: outputting a prompt to prompt that the running application is a malicious application when the running application is a malicious application.

15. The method as described in claim 13 wherein the method of executing a safeguard operation to protect the electronic device when the running application is a malicious application comprises: disabling the running application when the running application is a malicious application.

16. The method as described in claim 13, further comprising:
computing a malicious coefficient of the hardware modules being used which are not the hardware modules corresponding to the running application in the table; and
executing the safeguard operation according to the computed malicious coefficient.

17. The method as described in claim 16, wherein the method of executing the safeguard operation according to the computed malicious coefficient comprises: outputting a prompt to prompt that the running application is a malicious application when the computed malicious coefficient is less than a preset value.

18. The method as described in claim 16, wherein the method of executing the safeguard operation according to the computed malicious coefficient comprises: disabling the running application when the malicious coefficient is equal to or greater than the preset value.
